(19) United States
(12) Patent Application Publication
(10) Pub. No.: US 2023/0112634 A1
(43) Pub. Date: Apr. 13, 2023

(54) METHODS AND SYSTEMS OF SYNCHRONOUS SENDING OF STATE SHARING OF UAV TEAMS

(71) Applicant: University of Electronic Science and Technology China, Chengdu (CN)

(72) Inventors: YULIN WANG, CHENGDU (CN); YU LUO, CHENGDU (CN); SIYU ZHAN, CHENGDU (CN); RUIQIN WU, CHENGDU (CN)

(21) Appl. No.: 17/456,949

(22) Filed: Nov. 30, 2021

(30) Foreign Application Priority Data
Sep. 30, 2021 (CN) 202111156726.0

(51) Int. Cl. H04L 65/80; H04L 43/04; H04W 56/00

(52) U.S. Cl. CPC H04L 65/80; H04L 43/04; H04W 56/001

(57) ABSTRACT

Methods and systems of synchronous sending are described for state sharing of UAV teams. Most state data of UAV is nonstationary time series, the state data collected or perceived by sensors of UAV is segmented automatically with changepoint detection methods in real time. Each segment is sliced non-uniformly, and all the data of each slice is summarized. The summary result of each slice is finally sent for sharing among UAV teams. The changing of state generation parameters of UAV flight or working can be discovered and the segments are non-uniformly sliced automatically in the invention. The shared data is sent in time when the state changes irregularly while it is sent at large intervals when the state changes regularly. The invention reduces the number of sending substantially and then decreases the bandwidth consumption of state sharing of UAV teams, without decreasing the real time of state sharing.

### CROSS-REFERENCE TO RELATED APPLICATIONS

This application claims priority to Chinese Patent Application No. 202111156726.0 with a filing date of Sep. 30^{th}, 2021. The content of the aforementioned application, including any intervening amendments thereto, are incorporated herein by reference.

### BACKGROUND

### Technical Field

The present disclosure generally relates to the coordination technology of UAV teams and, more particularly, to synchronous sending methods and systems for state sharing of UAV teams.

### Description of the Related Art

To achieve steady flight and particular functions, UAVs usually carry a large variety of sensors, such as accelerometer, gyroscope, magnetic compass, barometer, ultrasonic sensor, GPS, high-definition camera, radar, etc. The sensors have different sampling frequency, ranging from a few Hz to hundreds of MHz. Due to the limit of wireless network bandwidth and the changing of communication topology of UAV teams, it is inefficient and even impossible for large team members to send directly the data collected by sensors to all the members in the UAV team. In order to achieve the task coordination such as task allocation or task synchronization, etc., each member of a UAV team needs to send the state data of flight and working to other members in real time. Although the enquiry mode is able to get the real-time state of each team member on demand, it is not considered here on account of long delay and the lack of recording past state of each other member. Because it is uncertain that which kind and which state information of UAV will be used during UAV team coordination, the active sharing mode is considered here, that is, a UAV actively shares its state information with other team members in real time. The active sharing mode has high real-time performance and sufficient information sharing, but it has the drawback of large bandwidth consumption. As a mobile perceptual computing device, a UAV has the characteristics of high movement speed and wide perceptual coverage. When the distance between UAV members is larger than their respective communication range, they can only communicate hop by hop. This will exacerbate the contradiction between the real-time of sharing state information and the bandwidth limitation in UAV teams.

To address the contradiction, existing technical solutions can be classified into two categories. One is to compress the perceptual data of state time series and then to send for sharing, for instance, real-time audio compression transmission protocols: G.711 and G.729, and real-time video compression transmission protocols: H.261 and H.263. The other is to decrease the sampling frequency by resampling the perceptual data, so as to reduce the number of sending. Without changing the sending frequency, the compression method decreases bandwidth consumption by shortening each transmitted packet. On the premise of unchanging the packet length, the second method decreases bandwidth consumption by reducing the number of sending. Although these two kinds of methods are classified by different technical roadmaps, they can be combined in real-world applications. If the frequency of down-sampling and sending is too low, the second method may easily cause the UAV team to be unable to perceive the changing of dynamic environment in real time, so that efficient coordination cannot be achieved. On the contrary, if the frequency of down-sampling and sending is too high, the goal of reducing the number of sending and bandwidth consumption cannot be achieved.

### SUMMARY OF THE DESCRIPTION

In view of the drawbacks of existing down-sampling technology of data sharing and sending, the disclosure proposes a synchronous sending method and system for state sharing of UAV teams. Based on the fact that most state data of UAVs are nonstationary time series, the state data collected or perceived by each sensor of UAV is automatically segmented in real time in the proposed invention. Each segment is non-uniformly sliced, and then each slice is summarized, at last the summary result is sent for sharing among the UAV team.

Without decreasing the real time performance of state sharing among UAV teams, the invention reduces the number of sending data packets, so that low bandwidth consumption and low transmission delay can be achieved for state sharing among UAV team members.

### BRIEF DESCRIPTION OF THE DRAWINGS

The drawings help to provide further understanding of the technical scheme of the invention, and form a part hereof. They explain the invention with the embodiments of the invention, but do not confine the technical scheme of the invention.

FIG. 1 is a diagram showing an example of changepoint segmentation result of state time series of UAV;

FIG. 2 is a diagram showing an example of intra-segment slicing result of state time series of UAV.

FIG. 3 is a flowchart illustrating the online real-time segmentation of state time series of UAV.

FIG. 4 is a flowchart illustrating the intra-segment slicing and sending of state time series of UAV.

FIG. 5 is a flowchart illustrating the slice length adjustment of state time series of UAV.

FIG. 6 is a block diagram illustrating the synchronous sending system for state sharing of UAV teams.

### DESCRIPTION OF THE PREFERRED EMBODIMENTS

To explain the purpose, the technical scheme and advantages of the invention more clearly, the typical embodiment of the invention is descripted in detail with the attached drawings. Obviously, the descripted embodiment is an embodiment of the invention in some cases, rather than in all the cases. It is noteworthy that the embodiments of the invention or the features of the embodiment can be combined freely in the case of no conflicts.

The given steps of the flowcharts in the attached drawings can be executed in a computer system, which can run a group of computer executable instructions. Although the flowcharts have given the logical order, the given or described steps can be executed in some cases in a different order from here.

The application scope of the embodiment is the case of state sharing and synchronous processing during the coordination of UAV teams. The executor of the embodiment is the information sharing and synchronous processing system in UAV. The system can be the information computing and processing platform of aircrafts, and it can be set individually or even attached to the flight control processors or other existing computing processors. Because information sharing is necessary for UAV teams to complete specific tasks coordinately and it is mainly accomplished through wireless communication, there are wireless communication modules except the processors in the synchronous processing system of information sharing, including but not limiting to WiFi, Bluetooth, mobile communication, dedicated communication, etc. Moreover, because of the great mobility of UAV, the state information for sharing includes position, attitude and various states for performing specific tasks. Therefore, the synchronous processing system of information sharing also includes various state sensing modules, such as spatial position sensing module, flight attitude sensing module, image and sound sensing module, etc.

During the flight process of UAV, all kinds of sensors collect various states continually. The features of state data may dynamically alter with the changing of working state of UAV. The basic idea of the invention is to adaptively send the data to be shared according to the feature changing of state data, especially the changing of generation parameter. The frequency of sharing and sending is high when the features change rapidly, and the frequency is low or remains stable when the features change slowly. Thus, the invention includes mainly two parts. One is the real-time detection of feature changing of time series, which is herein called the online real-time segmentation. The other is the non-uniform slicing of stationary time series, which is called the intra-segment slicing.

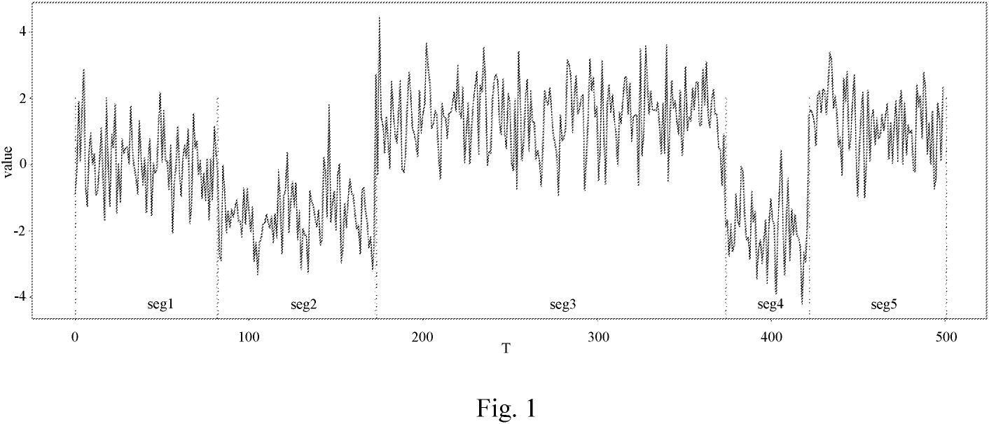

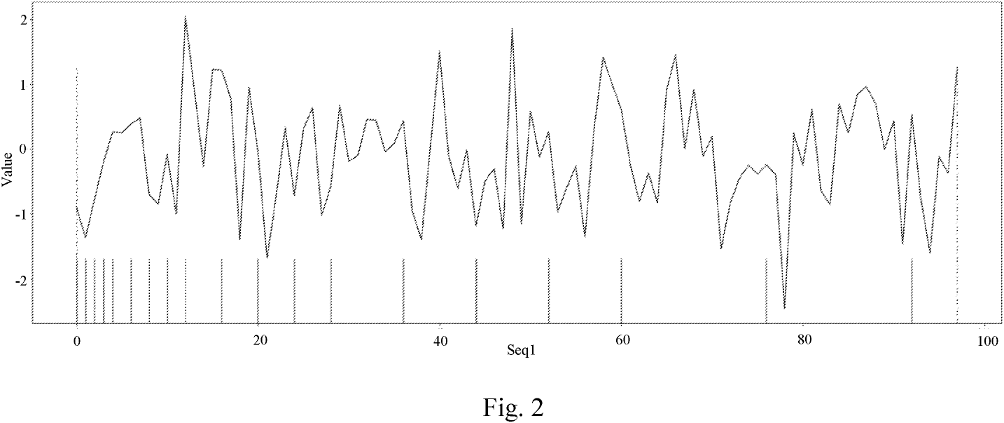

To illustrate the method of the invention better, the result examples of two main parts of the invention method are given in FIG. 1 and FIG. 2 respectively. An example of changepoint segmentation result of state time series of UAV is shown in FIG. 1. The abscissa is the serial number of time T, ranging from 0 to 500, which means there are 500 data points in time domain. Since a UAV is able to work continuously, the serial number can increase infinitely in real-world tasks. The ordinate is the state value at each time point. The range is here [-6, 6], which can be arbitrary in real-world. The curve shows the time series data, and the vertical dotted lines indicate the changepoint positions of time series, namely the segmentation position. The 500 data points of time series are divided in FIG. 1 into four segments: Seg1, Seg2, Seg3 and Seg4.

The total number of segments and the length of each segment are automatically determined by the online changepoint segmentation method in FIG. 1. The goal of the method is to segment fast the data with shorter length when the nonstationary state of UAV changes rapidly and on the contrary, to segment slowly with longer length when the nonstationary state changes slowly. In addition, it does not segment the data when the state of UAV changes steady.

An example of segment slicing result of state time series of UAV is shown in FIG. 2. The meanings of the abscissa, the ordinate, the vertical dotted lines and the curve are the same as FIG. 1 and the vertical solid lines shows the intra-segment slicing result in FIG. 2. The state time series of the figure is only one segment obtained by the online changepoint segmentation process. The segment is further divided into 18 slices. Because the data between the right dotted line and the last vertical solid line does not reach the current slice length, it is not able to form a whole slice and is ignored. Among the 18 slices, the length of the first four slices is 1, the length of the 5th-8th slices is 2, the length of the 9th-12 th slices is 4, the length of the 13th-16th slices is 8 and the length of the last two slices is 16. It indicates that the intra-segment slice length is non-uniform, and that the first part slices are shorter than the latter part slices. The adjustment of slice length is handled by a dedicated process named slice length adjustment, which is described in detail later.

Each slice has a process of data summarization and sending in FIG. 2, that is, each slice corresponds to one sending operation for sharing. It takes only 18 times to finish sending more than 120 data points of the entire segment. It is shown from FIG. 1 and FIG. 2 that without affecting the coordination performance of UAV team, the invention reduces drastically the sending number of state sharing by adjusting automatically the sending intervals of state sharing according to the speed of the nonstationary state changing of UAV. It decreases the bandwidth consumption for real time state sharing of UAV team correspondingly.

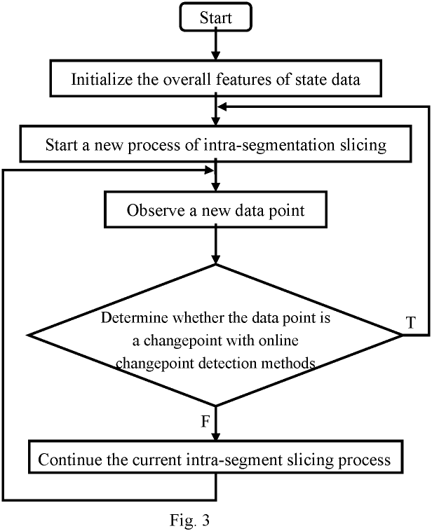

The flowchart of the online real-time segmentation of state time series of UAV is illustrated in FIG. 3, which contains the following steps.

Step S100. Initialize the overall features of state data. The overall features include but are not limited to mean, variance and prior distribution of segment length etc. The prior values of the overall features can be obtained manually by analyzing the historical data, or automatically by machine learning methods.

Step S200. Start a new process of intra-segmentation slicing. In the process of data segmenting and slicing of time series, one time series contains one or more segments. Similarly, one segment contains one or more slices. Both the first segment and its first slice start from the first data point of time series.

Step S300. Observe a new data point. The sensors or the perceptrons of UAV collect the state data continually at a fixed frequency. The state data could herein be one-dimensional such as speed or acceleration, two-dimensional such as data matrix of image, and three or even more dimensional such as spatial position, etc.

Step S400. Determine whether the data point is a changepoint with online changepoint detection methods. If so, go to step S200, otherwise go to step S500. The state time series of UAV is segmented with changepoints in the invention. A changepoint denotes the abrupt changing of generation parameters of series data. In the coordination process of UAVs, it is manifested by the abrupt changing of flight state/model or working state/model, such as abrupt steering, abrupt accelerating or abrupt landing etc. The goal of changepoint detection is to divide series data into different segments, the generation parameters of which are consistent and the state changing of which is stationary in each segment.

The changepoint detection mentioned above can herein be any existing methods, for example, the online Bayesian changepoint detection method, the classical CUSMU method, Poisson process with varying rates, hidden Markov model with a changing transition matrix, Gaussian process changepoint models and two-phase linear regression, etc.

When a data point is determined as a changepoint, it is indicated that the generation parameters of the data point has changed, that is, the generation parameters are different from that of the previous segment data. Thus, the data point should be classified into a new segment, and a new intra-segment slicing process needs performing.

Step S500. Continue the current intra-segment slicing process, and then go to step S300. When the data point is not a changepoint, it is shown that the current segment has not ended and the data point still belongs to the current segment. Therefore, continue the current intra-segment slicing.

Each segment needs to be further divided into slices in order to send state data for sharing. Since the generation parameters of all the data points of one segment are consistent, these data points cannot be further divided automatically. Thus, these data points are sliced manually in the invention. During the coordination of UAV teams, a UAV is able to collaborate better with others if it can accurately predict the future state of other team members. Therefore, once the generation parameters of UAV A change, the new state data needs to be timely sent to other team members so that other member B can be aware of the changing of state and generation parameters of UAV A. Furthermore, UAV B can fast adjust the predictive model parameters of UAV A so as to accurately predict the future state of UAV A. When the state generation parameters of A remain unchanged, it is not necessary for UAV B to adjust the predictive model parameters of UAV A on this occasion since B has already obtained the predictive model parameters of UAV A by previous sharing of A. Based on the above idea, the principle of intra-segment slicing is as follows. The state data points should be intensively sent timely to other team members at the beginning of each segment, so that other team members can fast obtain the predictive model parameters of the segment. After UAV B has obtained the predictive model parameters of A, UAV A should reduce the number of sending state data, or even stop sending state data until the next segment begins.

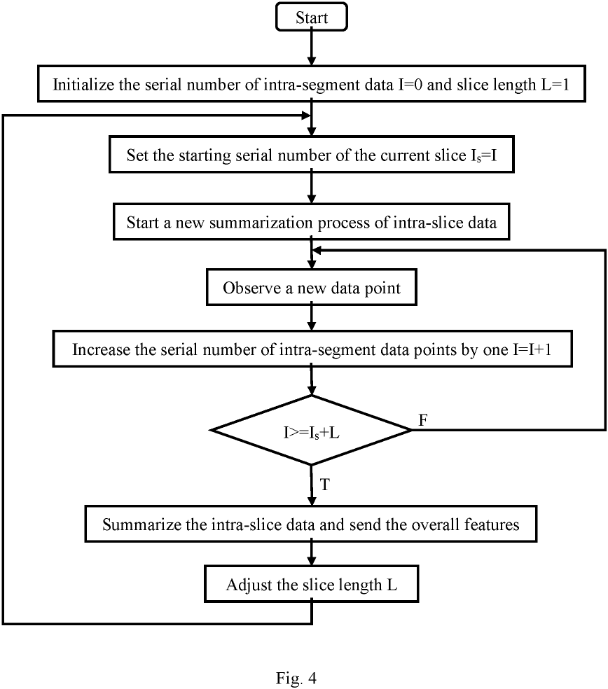

The flowchart of the intra-segment slicing and sending of state time series of UAV is illustrated in FIG. 4, which contains the following steps.

Step T100. Initialize the serial number of intra-segment data I=0 and the slice length L=1. Each segment has its own intra-segment slicing process, so the data points of each segment need to be renumbered. Set the serial number I of the first data point as 0 in order to execute the slicing process with intra-segment serial numbers. In addition, set the length L of the first slice as 1 herein. Generally speaking, the length of the first segments is less than that of the latter segments. The initial value of the serial number of data points and the initial length of slices can be adjusted appropriately according to the collection frequency of state in practice.

Step T200. Set the starting serial number of the current slice Iₛ=I. The starting serial number is the position which a slice starts from, and it indicates that a new slice has started.

Step T300. Start a new summarization process of intra-slice data. The summarization process of intra-slice data could be to extract the mean value/variance for one-dimensional data, or the eigenvalue/eigenvector etc. for two-dimensional data, Similar process could be applied to the data with higher dimension, and the goal is to obtain the overall features of all the data of the slice.

Step T400. Observe a new data point. Similar to step S300 of the online real time segmentation process, this step is triggered by a new data point collected by sensors or perceptrons. In other words, when a new data point is collected, it is required to determine whether the data point is a changepoint and which slice the data point belongs to.

Step T500. Increase the serial number of intra-segment data points by one I=I+1. Every time a new data is obtained, the serial number of intra-segment data points is increased by 1, and the current slice adds a data point accordingly.

Step T600. Compare whether the serial number of intra-segment data points I is equal to or larger than the sum of the starting serial number Iₛ and the current slice length L, that is, judge whether I >= Iₛ+1. If so, it indicates that the current slice has finished, and then execute the intra-slice summarization and sending process, that is, go to step T700. Otherwise, it is shown that the current data point still belongs to the current slice, and then continue to observe the next data, that is, go to step T400.

Step T700. Summarize the intra-slice data and send the overall features. When a slice ends, the summarization process of the entire slice data has accordingly finished, that is, the overall features of the entire slice data, such as mean and variance, are obtained. Then the overall features of the slice are sent to other UAV team members through wireless communication.

Step T800. Adjust the slice length L. It is known from the principle of intra-segment slicing that the length of the latter slices is greater than or is equal to that of the first ones. The adjustment process will be described in detail later.

The parameters of data generation model of the same segment can be extracted not only in other UAV team members, but also in the local machine. The method in FIG. 4 is to share the overall features of slice data or slice data directly, and the parameters of data generation model are extracted independently by other team members. An alternative method can be also applied here. That is, for a new segment, a UAV first extracts the parameters of data generation model, and then sends the parameters to other team members. The alternative method can also achieve the goal of reducing the number of sending state data.

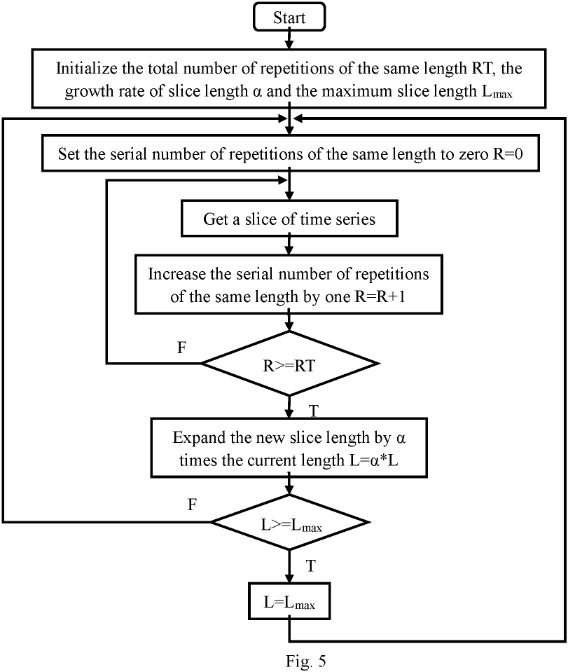

The flowchart of slicing length adjustment of state time series of UAV is illustrated in FIG. 5, which contains the following steps.

Step T801. Initialize the total number of repetitions of the same length RT, the growth rate of slice length α and the maximum slice length Lₘₐₓ. The slice length increases in steps in the invention, that is, there are adjacent RT slices with the same length. Therefore, the three parameters control the step size of slices, the growth rate of slice length, and the maximum slice length respectively. Obviously, the total number of repetitions of the same length RT is an integer larger than or equal to 1, the growth rate of slice length α is a floating number larger than 1, and the maximum slice length Lₘₐₓ is an integer larger than 1.

Step T802. Set the serial number of repetitions of the same length to zero, i.e. R=0. Since the same length will repeat RT times when slicing, the serial number of repetitions is first set to 0, which indicates the beginning of a new stair.

Step T803. Get a slice of time series. This step is triggered by the slice data summarization and sending of the intra-segment slicing and sending process, i.e. step T700 in FIG. 4.

Step T804. Increase the serial number of repetitions of the same length by 1, i.e. R=R+1. It shows that the current slice length is the same as the corresponding slice length of the current stair, and the current stair width increases 1.

Step T805. Determine whether the current serial number of repetitions of the same length R is larger than or is equal to the total number of repetitions of the same length RT. If so, it indicates that the current stair has ended and a new stair should start, then go to step T806. Otherwise, go to step T803 to continue the current stair. That is, the new slices will remain the same length as that of the slices of the current stair.

Step T806. Expand the new slice length to α times the current slice length, i.e. L=α^{∗}L. Since the growth rate of slice length α is a floating number greater than 1, the new slice length is greater than the previous slice length, so as to increase the slice length gradually.

Step T807. Determine whether the new slice length L is larger than or is equal to the maximum slice length Lₘₐₓ. If so, execute step T808 to adjust the new slice length as the maximum slice length. Otherwise, go to step T802 to perform the intra-segment slicing operation with the new slice length.

Step T808. Set the new slice length as the maximum slice length L = Lₘₐₓ, and then go to step T802. That is, adjust the new slice length as the maximum slice length, and then perform the intra-segment slicing operation with the new slice length.

The method of adjusting the slice length is not fixed. The length could rise continuously or in steps. The adjustment method shown in FIG. 5 is an approach of stepwise increment. In addition to the above two methods, there are some other special methods that can realize the dynamical adjustment of slice length. For example, the fixed vector method, <1,1,1,1,4,4,4,4...>, indicates the length of the first four slices is 1 and that of the following four is 4, etc. These adjustment methods with slight modification can also be applied to the invention.

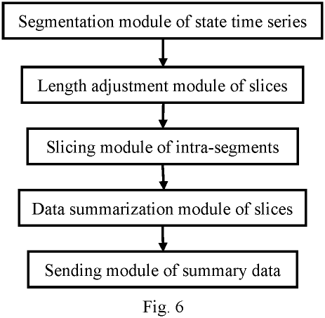

According to the above synchronous sending method for state sharing of UAV teams, a synchronous sending system for state sharing of UAV team is further provided in the invention. The block diagram of the synchronous sending system for state sharing of UAV teams is illustrate in FIG. 6, comprising:

Segmentation module of state time series. It detects the changing of generation parameters of state automatically by analyzing state time series of UAV. Every time the generation parameters of state series model change, the state series would be divided into a new segment. The number of segments and the length of each segment are not fixed but determined by the changing speed of state generation parameters of UAV. When the flight and working state of UAVs is nonstationary and changes slowly, the module segments the series data slowly or does not segment. When the working and flight state is nonstationary and changes rapidly, the module segments the series data fast. In addition, it does not re-segment when the state is stationary. Every time a new state is collected or received, the module would be executed once. Therefore, the module is always working during the whole flight and working process of UAVs.

Length adjustment module of slices. It is used for adjusting the length of each slice dynamically in a segment. Notice that the length of intra-segment slice is not fixed, but increased gradually until the maximum slice length is reached. Besides, the slice length is adjusted by the principles of intra-segment slicing. The goal of intra-segment slicing principle is that other UAV team members can quickly perceive the state changing of UAV in real time with as few reception times as possible. Since the state generation parameters are fixed in the same segment, the length of first slices should be shorter so that other members can get the generation parameters of a new segment in time. Reversely, after the state generation parameters have been gotten, the slice length should be increased or fixed to the maximum interval in order to decrease the times of sending. Therefore, the length of intra-segment slicing is not fixed but increases gradually.

Slicing module of intra-segments. It is used for slicing each segment. One segment contains at least one slice and the length of each slice is automatically determined by the length adjustment module of slices. The module is always working during the flight and working process of UAVs. The new intra-segment slicing would be performed for every new segment.

Data summarization module of slices. It is used for extracting the overall features of state data of each slice, and the overall features are sent by UAV as the content of state sharing. The overall features of state data include but are not limited to mean, variance, etc. The module is also always working during the whole flight and working process of UAV. The data summarization operation is performed for every slice of a segment except for the last incomplete one. When the slice length is 1, the result of data summarization is the state data itself.

Sending module of summary data. It is used for sending the overall features of slice data to other members of a UAV team so that other UAVs can perceive the changing of state and generation parameters in real time. The sending way is wireless, which includes but is not limited to WiFi, mobile communication, private communication, etc. This module is always working during the whole flight and working process of UAV. It sends the summary data of each slice only once.

The above module division is only one case among all the embodiments of the invention. The module recombination and rearrangement also belong to the protection scope of the invention.

Obviously, the above embodiments are only some examples to illustrate the invention clearly, rather than the embodiment limitation of the invention. One of ordinary skill in the art can make some modification or change with different forms based on the invention. Herein it is unnecessary also unable to enumerate all the embodiments. Therefore, all the changes or modifications that come within the meaning and range of equivalency of the claims are to be embraced within their scope.

We claim:

1. A method for synchronous sending of state sharing of UAV teams, the method comprising:
A UAV segments the original state time series collected or perceived by sensors with changepoint detection methods, and slices each segment non-uniformly, then summarizes all the data points of each slice, and ultimately sends the overall features obtained by summarization within the UAV team for sharing;
Among the above steps, the changepoint segmentation process adopts the online real time changepoint detection methods; The corresponding data point of changepoint is taken as the starting point of a new segment: the previous data belongs to one segment and the following data belongs to another segment; In the non-uniform slicing process, the length of each slice increases gradually in steps until reaching the predetermined maximum slice length, and after that, the system slices with the maximum length; The data summarization process is to extract the overall features of all the data points of a slice of time series.

2. The method of claim 1, wherein said changepoint segmentation of state time series comprises the following steps:
S100 Initialize the overall features of state data;
S200 Start a new process of intra-segmentation slicing;
S300 Observe a new data point;
S400 Determine whether the data point is a changepoint with online changepoint detection methods; If so, go to step S200, otherwise go to step S500;
S500 Continue the current intra-segmentation slicing process, and then go to S300.

3. The method of claim 1, wherein said non-uniform slicing of segments of state time series comprises the following steps:
T100 Initialize the serial number of intra-segment data I=0 and the slice length L=1;
T200 Set the starting serial number of the current slice Iₛ=I;
T300 Start a new summarization process of intra-slice data;
T400 Observe a new data point;
T500 Increase the serial number of intra-segment data points by one I=I+1;
T600 Determine whether the serial number of intra-segment data points I is equal to or larger than the sum of the starting serial number Iₛ and the current slice length L; If so, go to step T700, otherwise go to step T400;
T700 Summarize the intra-slice data and send the overall features;
T800 Adjust the slice length L.

4. The method of claim 3, wherein said slice length adjustment of state time series comprises the following steps:
T801 Initialize the total number of repetitions of the same length RT, the growth rate of slice length α and the maximum slice length Lₘₐₓ;
T802 Set the serial number of repetitions of the same length to zero R=0;
T803 Get a slice of time series;
T804 Increase the serial number of repetitions of the same length by one R=R+1;
T805 Determine whether the current serial number of repetitions of the same length R is larger than or is equal to the total number of repetitions of the same length RT, if so, go to step T806, otherwise go to step T803;
T806 Expand the new slice length by α times the current slice length L=α*L;
T807 Determine whether the new slice length L is larger than or is equal to the maximum slice length Lₘₐₓ, if so, go to step T808, otherwise go to step T802;
T808 Set the new slice length as the maximum slice length L = Lₘₐₓ, and then go to step T802.

5. A system of synchronous sending of state sharing of UAV teams, comprising:
Segmentation module of state time series that detects the changing of state generation parameters of UAV automatically by analyzing state time series of UAV, then divides the state time series into a new segment every time the changing of state generation parameters is detected;
Length adjustment module of slices that adjusts the length of each slice of a segment dynamically, and the length of intra-segment slices is not fixed, but increases gradually until the maximum slice length is reached;
Slicing module of intra-segments that slices each segment and each segment contains at least one slice, and the length of each slice is dynamically determined by the length adjustment module of slices;
Data summarization module of slices that extracts the overall features of state data of each slice, and the overall features are sent by UAV as the content of state sharing;
Sending module of summary data that sends the overall features of slice data to other members of a UAV team so that other UAVs can perceive the changing of state and generation parameters in real time.
